(19) United States
(12) Patent Application Publication
(10) Pub. No.: US 2018/0359348 A1
(43) Pub. Date: Dec. 13, 2018

(54) AUDIO CODING BASED ON WIRELESS EARPHONE CONFIGURATION

(71) Applicant: QUALCOMM Incorporated, San Diego, CA (US)

(72) Inventors: Ramprasad Katkam, Hyderabad (IN); Rajendra Prasad Katakam, Hyderabad (IN); Sasikanth Reddy Adapala, Hyderabad (IN)

(21) Appl. No.: 15/621,717

(22) Filed: Jun. 13, 2017

(51) Int. Cl. H04M 1/60; H04R 1/10; H04L 29/06; G06F 3/16

(52) U.S. Cl. CPC H04M 1/6066; H04R 1/10; H04M 2250/02; G06F 3/165; H04R 2420/07; H04L 65/607

(57) ABSTRACT

An earphone device includes wireless communication circuitry, a decoder coupled to the wireless communication circuitry, and a speaker coupled to the wireless communication circuitry. The wireless communication circuitry is configured to send, in accordance with an audio video remote control profile (AVRCP) protocol to a source device, a notification of a configuration corresponding to a left audio configuration or a right audio configuration. The decoder is configured to decode, based on the configuration, an audio stream from an audio signal to generate a decoded audio stream. The speaker is configured to generate an audio output based on the decoded audio stream.

### I. FIELD

The present disclosure is generally related to encoding and decoding an audio signal based on wireless earphone configuration.

### II. DESCRIPTION OF RELATED ART

Advances in technology have resulted in smaller and more powerful computing devices. For example, there currently exist a variety of portable personal computing devices, including wireless telephones such as mobile and smart phones, tablets, and laptop computers that are small, lightweight, and easily carried by users. These devices can communicate voice and data packets over wireless networks. Further, many such devices incorporate additional functionality such as a digital still camera, a digital video camera, a digital recorder, and a media player. Also, such devices can process executable instructions, including software applications, such as a web browser application, that can be used to access the Internet. Use of earphones with such devices is widespread. For example, a user may use earphones to hear audio output from a mobile phone.

Earphones are generally designed to be worn in a particular orientation. Typically, one earphone is labeled for the left ear and another earphone is labeled for the right ear. If a user does not check the labels before using the earphones, the user may wear the earphones incorrectly (i.e., the left earphone in the right ear). When the user is wearing the earphones in the incorrect orientation while watching a movie with surround sound (i.e., stereo channels), audio corresponding to actors or special effects is reversed relative to the video on the screen. Consequently, the user experience is adversely impacted.

### III. SUMMARY

In a particular aspect, an earphone device includes wireless communication circuitry, a decoder coupled to the wireless communication circuitry, and a speaker coupled to the decoder. The wireless communication circuitry is configured to send, in accordance with an audio video remote control profile (AVRCP) protocol to a source device, a notification of a configuration corresponding to a left audio configuration or a right audio configuration. The decoder is configured to decode, based on the configuration, an audio stream from an audio signal to generate a decoded audio stream. The speaker is configured to generate an audio output based on the decoded audio stream.

In another particular aspect, a method includes receiving, at a source device in accordance with an audio video remote control profile (AVRCP) protocol from a first earphone device, a first notification of a first configuration corresponding to a left audio configuration or a right audio configuration. The method also includes selecting, based at least in part on the first configuration, an audio mode corresponding to a stereo mode or a mono mode. The method further includes generating an encoded audio signal based on the audio mode. The method also includes transmitting the encoded audio signal to the first earphone device.

In another particular aspect, a computer-readable storage device stores instructions that, when executed by a processor, cause the processor to perform operations including sending, from an earphone device in accordance with an audio video remote control profile (AVRCP) protocol to a source device, a notification of a configuration corresponding to a left audio configuration or a right audio configuration. The operations also include decoding, based on the configuration, an audio stream from an audio signal to generate a decoded audio stream. The operations further include generating, at the earphone device, an audio output based on the decoded audio stream.

Other aspects, advantages, and features of the present disclosure will become apparent after review of the entire application, including the following sections: Brief Description of the Drawings, Detailed Description, and the Claims.

### IV. BRIEF DESCRIPTION OF THE DRAWINGS

FIG. 1 is a block diagram of a particular illustrative aspect of a system operable to perform audio encoding and audio decoding based on wireless earphone configuration;

FIG. 2 is a diagram to illustrate a particular aspect of an earphone of the system of FIG. 1;

FIG. 3 is a diagram to illustrate a particular aspect of the system of FIG. 1;

FIG. 4 is a table to illustrate a particular aspect of earphone audio configuration and corresponding audio mode of a source device of the system of FIG. 1;

FIG. 5 is a ladder diagram to illustrate a particular aspect of a method of operation of the system of FIG. 1;

FIG. 6 is a ladder diagram to illustrate a particular aspect of a method of operation of the system of FIG. 1;

FIG. 7 is a flow chart to illustrate a particular aspect of a method of audio decoding based on wireless earphone configuration;

FIG. 8 is a flow chart to illustrate another particular aspect of a method of audio encoding based on wireless earphone configuration; and

FIG. 9 is a block diagram of a device operable to perform audio coding based on wireless earphone configuration in accordance with the systems and methods of FIGS. 1-8.

### V. DETAILED DESCRIPTION

Systems and methods of audio coding based on wireless earphone configuration are disclosed. An earphone has an audio configuration (e.g., a left configuration or a right configuration). For example, a decoder of the earphone includes a register, and a value of the register indicates the configuration. The configuration indicates that the decoder is configured to decode a particular audio stream from a received audio signal. For example, a left configuration indicates that the decoder is configured to decode an audio stream corresponding to a left audio channel. A right configuration indicates that the decoder is configured to decode an audio stream corresponding to a right audio channel. As used herein, “right” is a descriptor to contrast with “left” and does not necessarily imply “correct” (e.g., “right” is not used herein as an opposite of “wrong”).

The earphone includes control circuitry configured to set the configuration based on sensor outputs indicating whether the earphone is inserted in the left ear or the right ear. For example, the control circuitry is configured to set the configuration based on the sensor outputs in response to detecting that the earphone has been inserted in an ear. To illustrate, the control circuitry is configured to update the configuration of the earphone from the left configuration to the right configuration based on sensor outputs indicating that the earphone has been inserted in the right ear.

The earphone includes wireless communication circuitry configured to send a notification of the configuration to a source device (e.g., a mobile phone). For example, the wireless communication circuitry is configured to send the notification in response to detecting one or more trigger events, such as activation of the earphone within a communication range of the source device. The wireless communication circuitry is configured to send the notification to the source device in accordance with an audio video remote control profile (AVRCP) protocol. The wireless communication circuitry and the source device support the AVRCP protocol. The AVRCP protocol is based on a specification (e.g., a Bluetooth® (a registered trademark of Bluetooth SIG, Inc., Washington) specification) promulgated by an industry group (e.g., Bluetooth® special interest group (SIG)). Using a supported communication protocol improves interoperability between devices from different manufacturers and reduces additional communication overhead associated with implementation of the audio coding techniques described herein.

The source device is configured to receive the notification and to determine an audio mode (e.g., a stereo mode or a mono mode) based at least in part on the configuration. For example, the source device includes an audio mode selector configured to select the stereo mode in response to determining that the configuration indicates one of the left configuration or the right configuration, and that a second notification from a second earphone indicates the other of the left configuration or the right configuration. When the earphone is inserted in one ear of a user and the second earphone is inserted in the other ear of the same user, the configuration indicates one of the left configuration or the right configuration and the second configuration indicates the other of the left configuration or the right configuration. The source device includes an encoder configured to generate an audio signal based on the audio mode (e.g., the stereo mode). The source device also includes wireless communication circuitry configured to transmit the audio signal to the earphone and to the second earphone.

The decoder of the earphone is configured to generate a first decoded audio stream by decoding, based on the configuration, a first audio stream from the audio signal. The second earphone is configured to generate, based on the second configuration, a second decoded audio stream from the audio signal. For example, the earphone having the right configuration generates a first decoded audio stream corresponding to a right audio channel, and the second earphone having the left configuration generates a second audio stream corresponding to the left audio channel. As another example, the earphone having the left configuration generates a first decoded audio stream corresponding to a left audio channel, and the second earphone having the right configuration generates a second audio stream corresponding to the right audio channel. The earphone includes a speaker configured to generate an audio output based on the first decoded audio stream. The second earphone is configured to generate a second audio output based on the second decoded audio stream. The user thus receives the left audio channel via an earphone that is detected in the left ear and receives the right audio channel via another earphone that is detected in the right ear. Automatic provision of a corresponding audio channel based on ear detection enables use of identical earphones for both ears. The user can place either earphone in the left ear or the right ear to receive the right audio channel through the earphone inserted in the right ear and the left audio channel through the earphone inserted in the left ear.

In some examples, the source device is configured to select the mono mode as the audio mode based at least in part on receiving the notification from the earphone. For example, the user inserts the earphone in one ear (e.g., the right ear) and does not insert a second earphone in the other ear (e.g., the left ear). The wireless communication circuitry of the earphone is configured to, in response to determining that the earphone has been inserted in the ear (e.g., the right ear), send a notification of a configuration (e.g., the right configuration) of the earphone to the source device. The audio mode selector of the source device is configured to select the mono mode as the audio mode in response to determining that no related notification has been received from another earphone within a particular duration of receiving the notification from the earphone. The encoder of the source device is configured to generate an audio signal based on the audio mode (e.g., the mono mode). The wireless communication circuitry of the source device is configured to transmit the audio signal to the earphone. The decoder of the earphone is configured to generate, in response to determining that the audio signal corresponds to the mono mode, a decoded audio stream by decoding a mono audio stream of the audio signal. The speaker of the earphone is configured to generate an audio output based on the decoded audio stream. The user with an earphone inserted in one ear and no earphone inserted in the other ear thus automatically receives a mono audio stream via the earphone.

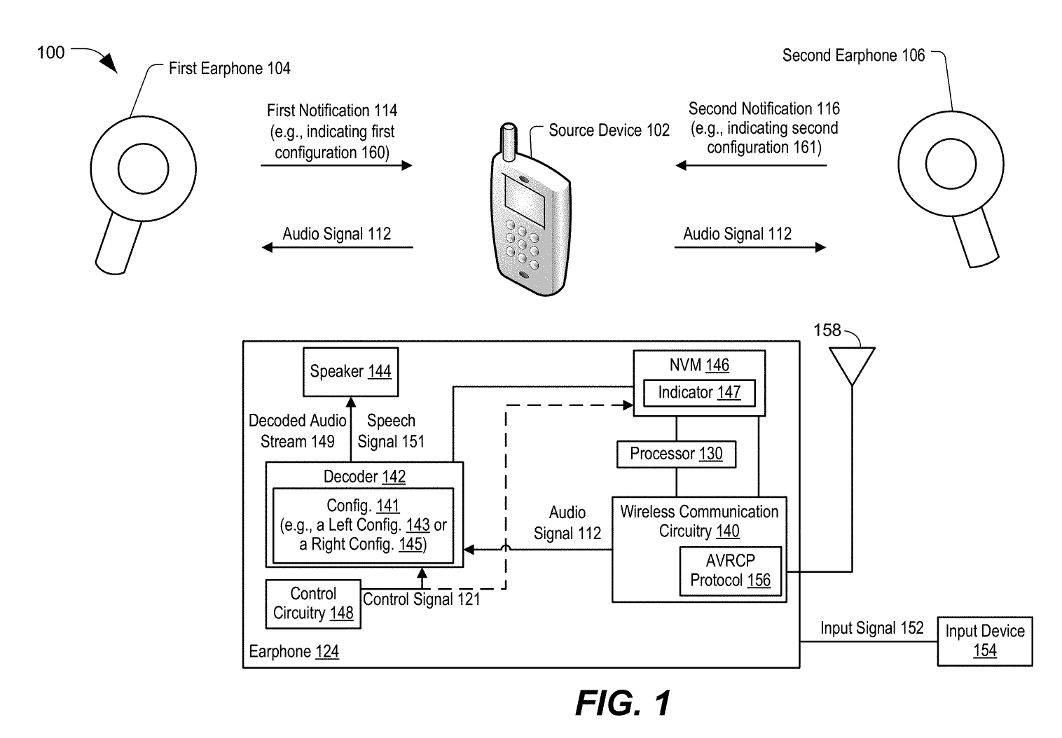

Referring to FIG. 1, a particular illustrative aspect of a system operable to perform audio coding based on wireless earphone configuration is disclosed and generally designated 100. The system 100 includes a source device 102 coupled to a first earphone 104. The system 100 may also include a second earphone 106.

An earphone 124 (e.g., an earphone device) illustrates internal components of the first earphone 104, the second earphone 106, or both. For example, each of the first earphone 104 and the second earphone 106 is separately configured to perform one or more operations described with reference to the earphone 124.

The earphone 124 includes wireless communication circuitry 140 coupled to an antenna 158. The wireless communication circuitry 140 is also coupled, via a decoder 142, to a speaker 144. The decoder 142 is coupled to control circuitry 148 and to a non-volatile memory (NVM) 146. The earphone 124 includes a processor 130 coupled to the NVM 146 and to the wireless communication circuitry 140. As used herein, “coupled” may include “communicatively coupled,” “electrically coupled,” or “physically coupled,” and combinations thereof. Two devices (or components) may be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled may be included in the same device or in different devices and may be connected via electronics, one or more connectors, or inductive coupling, as illustrative, non-limiting examples. In some implementations, two devices (or components) that are communicatively coupled, such as in electrical communication, may send and receive electrical signals (digital signals or analog signal) directly or indirectly, such as via one or more wires, buses, networks, etc.

The wireless communication circuitry 140 is configured to communicate with the source device 102 in accordance with an audio video remote control profile (AVRCP) protocol 156. The NVM 146 is configured to store an indicator 147 of a configuration 141 of the decoder 142. The configuration 141 includes a left configuration 143 or a right configuration 145. The left configuration 143 indicates that the decoder 142 is configured to decode a left audio stream of two stereo channels. The right configuration 145 indicates that the decoder 142 is configured to decode a right audio stream of the two stereo channels. In a particular implementation, the decoder 142 includes a register indicating the configuration 141. For example, a first value (e.g., 0) stored at the register indicates that the configuration 141 corresponds to the left configuration 143. A second value (e.g., 1) stored at the register indicates that the configuration 141 corresponds to the right configuration 145. In this implementation, “updating the configuration 141” corresponds to updating the value stored at the register, and “setting the configuration 141 to a particular value” corresponds to storing the particular value at the register.

The control circuitry 148 is configured to generate a control signal 121, as described herein. The decoder 142, responsive to the control signal 121, selectively updates the configuration 141, the indicator 147, or both. For example, the decoder 142 sets the configuration 141 to the left configuration 143 based on the control signal 121 corresponding to a first value (e.g., 0). Alternatively, the decoder 142 sets the configuration 141 to the right configuration 145 based on the control signal 121 corresponding to a second value (e.g., 1). The decoder 142 updates the indicator 147 to indicate the updated value of the configuration 141. In an alternative aspect, the NVM 146 receives the control signal 121 from the control circuitry 148 and updates the indicator 147 responsive to the control signal 121. For example, the NVM 146 sets the indicator 147 to indicate the left configuration 143 based on the control signal 121 corresponding to the first value (e.g., 0). As another example, the NVM 146 sets the indicator 147 to indicate the right configuration 145 based on the control signal 121 corresponding to the second value (e.g., 1).

During operation, the decoder 142 receives the indicator 147 from the NVM 146. For example, the decoder 142 receives the indicator 147 during a communication initiation phase. The processor 130 detects the communication initiation phase in response to one or more trigger events, such as detecting that the earphone 124 has entered a communication range of the source device 102, that the earphone 124 has been plugged into the source device 102, that the earphone 124 has been inserted in an ear, that a startup operation of the decoder 142 has been initiated, that a startup operation of the processor 130 has been initiated, that a request has been received from the source device 102, or a combination thereof. For example, the communication initiation phase may correspond to a user activating the earphone 124 within a communication range of the source device 102. The processor 130 retrieves the indicator 147 from the NVM 146 in response to detecting the communication initiation phase and provides the indicator 147 to the decoder 142. Alternatively, the processor 130, in response to detecting the communication initiation phase, instructs the decoder 142 to retrieve the indicator 147 from the NVM 146. The indicator 147 indicates a previous configuration of the decoder 142, a default configuration, or both. The decoder 142 sets the configuration 141 to the left configuration 143 or the right configuration 145 based on the value of the indicator 147. Setting the configuration 141 based on the value of the indicator 147 enables the previous configuration of the earphone 124 to be automatically restored. A user is likely to prefer the previous configuration for the earphone 124 so that the user may use the same earphone in the same ear. Having the previous configuration automatically restored may improve user experience.

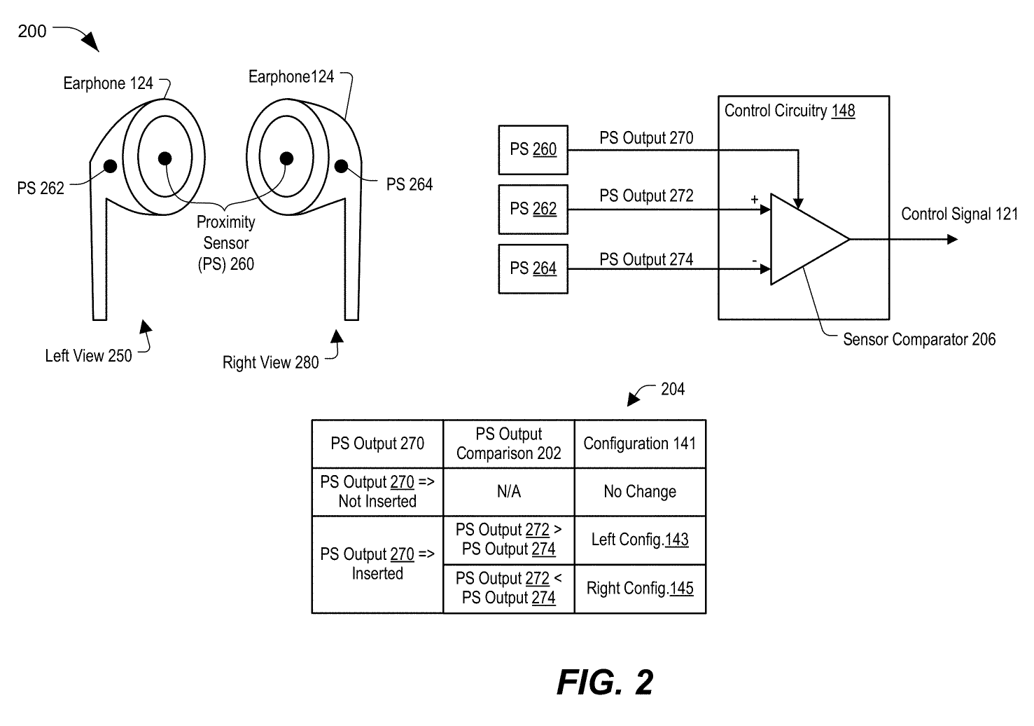

In a particular aspect, the earphone 124 includes one or more proximity sensors (PSs), as further described with reference to FIG. 2. Sensor outputs of the PSs may indicate whether the earphone 124 is inserted in a left ear or a right ear of a user. In this aspect, the control circuitry 148 generates (or updates) the control signal 121 responsive to the sensor outputs of the PSs, as further described with reference to FIG. 2. For example, when the sensor outputs of the PSs indicate that the earphone 124 is inserted in the left ear, the control circuitry 148 outputs the control signal 121 corresponding to a first value (e.g., 0) to set the configuration 141 to the left configuration 143. When the sensor outputs of the PSs indicate that the earphone 124 is inserted in the right ear, the control circuitry 148 outputs the control signal 121 corresponding to a second value (e.g., 1) to set the configuration 141 to the right configuration 145. In a particular implementation, the control circuitry 148 updates the control signal 121 based on the sensor outputs in response to detecting an update phase. The control circuitry 148 detects the update phase in response to one or more trigger events, such as detecting that the earphone 124 has entered a communication range of the source device 102, that the earphone 124 has been plugged into the source device 102, that the earphone 124 has been inserted in an ear, that a startup operation of the decoder 142 has been initiated, that a startup operation of the processor 130 has been initiated, that a request has been received from the source device 102, or a combination thereof. For example, the update phase may correspond to a user inserting the earphone 124 in an ear. To illustrate, the control circuitry 148 is configured to detect that the earphone 124 has been inserted in an ear based on a sensor output, as further described with reference to FIG. 1. Determining the configuration 141 based on the sensor outputs enables automatic updating of the configuration 141 of the earphone 124 based at least in part on determining whether the earphone 124 is inserted in the left ear of a user or the right ear of the user. Automatic update of the configuration 141 based on sensor outputs may improve user experience when the earphone 124 is moved from one ear to the other ear of the user.

The earphone 124 is configured to selectively update the configuration 141 and the indicator 147. For example, the earphone 124 includes (or is coupled to) an input device 154 (e.g., a button, a switch, or a microphone). The input device 154 provides an input signal 152 to the earphone 124. To illustrate, a user slides a switch (e.g., the input device 154) on the earphone 124 to change the configuration 141 of the earphone 124. The input signal 152 indicates a setting of the switch. In a particular implementation, a user speaks into a microphone (e.g., the input device 154) to the change the configuration 141 of the earphone 124. In this implementation, the input signal 152 (e.g., an input speech signal) corresponds to speech of the user.

The control circuitry 148 determines whether the input signal 152 indicates the left configuration 143 or the right configuration 145. For example, the control circuitry 148 determines that the input signal 152 indicates the left configuration 143 in response to determining that a value of the input signal 152 indicates a first setting of the input device 154 (e.g., a switch) that corresponds to the left configuration 143. Alternatively, the control circuitry 148 determines that the input signal 152 indicates the right configuration 145 in response to determining that a value of the input signal 152 indicates a second setting of the input device 154 (e.g., a switch) that corresponds to the right configuration 145. In a particular implementation, the control circuitry 148 determines that the input signal 152 indicates the left configuration 143 in response to determining that the input signal 152 corresponds to speech including the word “left.” Alternatively, the control circuitry 148 determines that the input signal 152 indicates the right configuration 145 in response to determining that the input signal 152 corresponds to speech that includes the word “right.” The control circuitry 148 performs speech recognition techniques to determine whether the input signal 152 corresponds to particular speech (e.g., “left” or “right”).

The control circuitry 148, responsive to the input signal 152, updates the control signal 121 to change the configuration 141, the indicator 147, or both. For example, the control circuitry 148, in response to determining that the input signal 152 indicates the left configuration 143, updates the control signal 121 to set the configuration 141 to the left configuration 143, set the indicator 147 to indicate the left configuration 143, or both. Alternatively, the control circuitry 148, in response to determining that the input signal 152 indicates the right configuration 145, updates the control signal 121 to set the configuration 141 to the right configuration 145, set the indicator 147 to indicate the right configuration 145, or both. Updating the configuration 141 based on the input signal 152 enables the user to override an automatic setting of the configuration 141. For example, the user may prefer to hear a left audio channel via the earphone 124 inserted in the right ear or to hear a right audio channel via the earphone 124 inserted in the left ear.

In a particular aspect, the control circuitry 148 is configured to allow or prevent an override of a restored, automatically detected, or user-selected configuration. In a particular example, the control circuitry 148, in response to detecting that a first criterion is satisfied, disables update of the control signal 121 based on the sensors outputs, the input signal 152, or a combination thereof. The control circuitry 148 determines that the first criterion is satisfied in response to detecting the communication initiation phase, receiving an input from a user, an instruction from the source device 102, the input signal 152 from the input device 154, or a combination thereof. Alternatively, the control circuitry 148, in response to detecting that a second criterion is satisfies, disables update of the control signal 121 based on the sensor outputs and enables update of the control signal 121 based on the input signal 152. The control circuitry 148 determines that the second criterion is satisfied in response to receiving an input from a user, an instruction from the source device 102, the input signal 152 from the input device 154, or a combination thereof. In a particular implementation, the control circuitry 148, in response to detecting that a third criterion is satisfied, enables update of the control signal 121 based on the sensor outputs and disables update of the control signal 121 based on the input signal 152. The control circuitry 148 determines that the third criterion is satisfied in response to detecting the update phase, receiving an input from a user, receiving an instruction from the source device 102, receiving an input signal from a second input device, or a combination thereof. For example, the earphone 124 is coupled to a second input device (e.g., a switch) that a user slides to activate automatic update of the configuration 141 based on the sensor outputs.

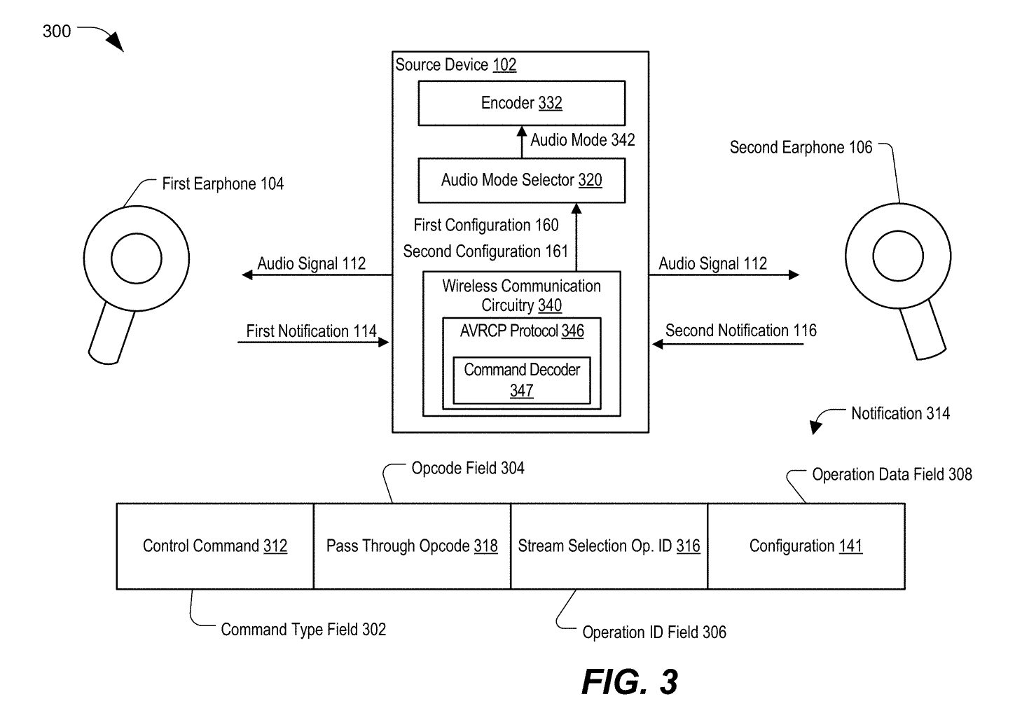

The wireless communication circuitry 140 sends a notification in accordance with the AVRCP protocol 156 to the source device 102, as further described with reference to FIG. 3. The notification indicates the configuration 141 of the decoder 142. Using the AVRCP protocol 156 enables the earphone 124 to communicate the configuration 141 to the source device 102 using communication protocols supported by the source device 102 and the earphone 124. In some examples, the notification corresponds to a command (e.g., a control command) of the AVRCP protocol 156. The source device 102 includes a command decoder configured to decode the command of the AVRCP protocol 156, as further described with reference to FIG. 3. The wireless communication circuitry 140 sends the notification to the source device 102 in response to detecting the communication initiation phase, detecting that the configuration 141 has been updated, receiving an instruction from the source device 102, receiving a user input, or a combination thereof. In a particular example, the first earphone 104 transmits a first notification 114 to the source device 102. The first notification 114 indicates a first configuration 160. In this example, the first earphone 104 corresponds to the earphone 124 and the first configuration 160 corresponds to the configuration 141. In another example, the second earphone 106 transmits a second notification 116 to the source device 102. The second notification 116 indicates a second configuration 161. In this example, the second earphone 106 corresponds to the earphone 124 and the second configuration 161 corresponds to the configuration 141.

The first earphone 104 and the second earphone 106 may be worn by the same user or by different users. The second configuration 161 may be distinct from the first configuration 160 if one of the first earphone 104 or the second earphone 106 is worn in a left ear and the other of the first earphone 104 or the second earphone 106 is worn in a right ear. The second configuration 161 may be the same as the first configuration 160 if the first earphone 104 is worn in a right ear of a first user and the second earphone 106 is worn in a right ear of a second user, or if the first earphone 104 is worn in a left ear the first user and the second earphone 106 is worn in a left ear of the second user. In some implementations, each of the first notification 114 and the second notification 116 includes a group identifier indicating that the first earphone 104 and the second earphone 106 are members of the same group.

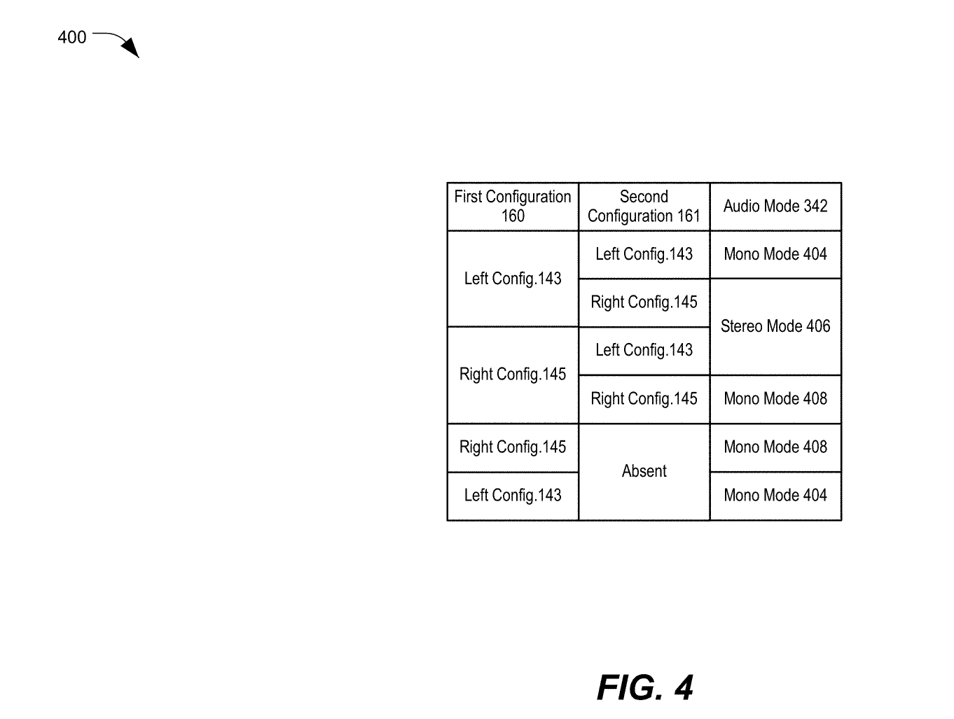

The source device 102 selects an audio mode based on the first notification 114, the second notification 116, or both, as further described with reference to FIGS. 3-4. The selected audio mode includes a stereo mode or a mono mode. For example, the source device 102 designates the stereo mode as the audio mode in response to determining that the first configuration 160 corresponds to one of the left configuration 143 or the right configuration 145 and that the second configuration 161 corresponds to the other of the left configuration 143 or the right configuration 145. In another example, the user inserts the first earphone 104 in one ear and does not insert any earphone in the other ear. In this example, the source device 102 designates the mono mode as the audio mode in response to determining that the second notification 116 is not received from the second earphone 106 within a particular time interval of receiving the first notification 114. The source device 102 generates an audio signal 112 corresponding to the selected audio mode. The audio signal 112 corresponding to the stereo mode includes a left audio stream and a right audio stream. The audio signal 112 corresponding to the mono mode includes a mono audio stream. The source device 102 transmits the audio signal 112 to the first earphone 104, to the second earphone 106, or both.

The earphone 124 (e.g., the first earphone 104 or the second earphone 106) receives the audio signal 112 from the source device 102. For example, the wireless communication circuitry 140 receives the audio signal 112 from the source device 102 and provides the audio signal 112 to the decoder 142. The decoder 142 generates a decoded audio stream 149 corresponding to the audio signal 112. In a particular aspect, the decoder 142, in response to determining that the audio signal 112 corresponds to the mono mode, generates a decoded audio stream 149 by decoding the mono audio stream of the audio signal 112. Alternatively, the decoder 142, in response to determining that the audio signal 112 corresponds to the stereo mode, generates the decoded audio stream 149 based on the configuration 141. For example, the decoder 142, in response to determining that the configuration 141 corresponds to the left configuration 143, generates the decoded audio stream 149 by decoding the left audio stream of the audio signal 112. Alternatively, the decoder 142, in response to determining that the configuration 141 corresponds to the right configuration 145, generates the decoded audio stream 149 by decoding the right audio stream of the audio signal 112. The decoder 142 provides the decoded audio stream 149 to the speaker 144. In a particular example, a user with the first earphone 104 in the left ear and the second earphone 106 in the right ear hears the left audio channel of the audio signal 112 via the first earphone 104 and hears the right audio channel of the audio signal 112 via the second earphone 106. In another example, a user with the first earphone 104 in one ear and no earphone in the other ear hears a mono audio channel via the first earphone 104.

In a particular aspect, the decoder 142 is configured to provide a speech signal 151 to the speaker 144. The speech signal 151 indicates the configuration 141. For example, the speech signal 151 corresponds to speech (e.g., “left configuration”) when the configuration 141 corresponds to the left configuration 143. Alternatively, the speech signal 151 corresponds to speech (e.g., “right configuration”) when the configuration 141 corresponds to the right configuration 145.

The speech signal 151 may be selected by the earphone 124 or by the source device 102. For example, the source device 102 transmits the speech signal 151 to the earphone 124 in response to receiving the notification from the earphone 124 indicating the configuration 141. To illustrate, the source device 102, in response to receiving the first notification 114 from the first earphone 104, selects a first speech signal (e.g., the speech signal 151) based on the first configuration 160 and transmits the first speech signal to the first earphone 104. The source device 102 designates a first signal as the first speech signal in response to determining that the first configuration 160 includes the left configuration 143 and that the first signal corresponds to speech including the word “left.” Alternatively, the source device 102 designates a second signal as the first speech signal in response to determining that the first configuration 160 includes the right configuration 145 and that the second signal corresponds to speech including the word “right.” The source device 102 transmits the first speech signal (e.g., the speech signal 151) to the first earphone 104. Similarly, the source device 102, in response to receiving the second notification 116 from the second earphone 106, selects a second speech signal (e.g., the speech signal 151) based on the second configuration 161 and transmits the second speech signal to the second earphone 106. The decoder 142 provides the speech signal 151 received from the source device 102 to the speaker 144.

Alternatively, the earphone 124 may select the speech signal 151. For example, the decoder 142 selects the speech signal 151 based on the configuration 141. To illustrate, the decoder 142 selects a first speech signal from a plurality of speech signals as the speech signal 151 in response to determining that the configuration 141 includes the left configuration 143 and that the first speech signal corresponds to speech including the word “left.” Alternatively, the decoder 142 selects a second speech signal from a plurality of speech signals as the speech signal 151 in response to detecting that the configuration 141 includes the right configuration 145 and that the second speech signal corresponds to speech including the word “right.” The decoder 142 determines that a particular speech signal corresponds to speech including a particular word in response to determining that text associated with the particular speech signal includes the particular word. The decoder 142 provides the speech signal 151 to the speaker 144.

The decoder 142 may provide the speech signal 151 to the speaker 144 in response to one or more events. In a particular implementation, the decoder 142 provides the speech signal 151 to the speaker 144 in response to determining that the configuration 141 has been updated from the left configuration 143 to the right configuration 145 or from the right configuration 145 to the left configuration 143. In a particular implementation, the decoder 142 provides the speech signal 151 to the speaker 144 in response to receiving the input signal 152 from the input device 154, another input signal from another input device, an instruction from the source device 102, an instruction from the processor 130, or a combination thereof. In a particular implementation, the decoder 142 provides the speech signal 151 to the speaker 144 in response to detecting a state (e.g., an initialization state) of the decoder 142. Providing the speech signal 151 to the speaker 144 enables a user to determine the configuration 141 of the earphone 124 and determine whether to use the input device 154 to override the automatic setting of the configuration 141.

The system 100 thus enables the earphone 124 to automatically update the configuration 141 based on determining whether the earphone 124 is inserted in the right ear or the left ear of the user and to send a notification of the configuration 141 in accordance with the AVRCP protocol 156 to the source device 102. The source device 102 selects an audio mode (e.g., a stereo mode or a mono mode) based at least in part on the configuration 141, generates the audio signal 112 corresponding to the selected audio mode, and sends the audio signal 112 to the earphone 124. A user thus automatically receives a mono audio channel or a stereo audio channel based at least in part on whether the earphone 124 is inserted in the right ear or the left ear of the user. Identical earphones can be used instead of a dedicated left earphone and a dedicated right earphone. Replacement costs of identical earphones may be lower than replacement costs of dedicated earphones. For example, a spare earphone can be a replacement for either of a pair of identical earphones. The cost of buying a single spare earphone is lower than the cost of buying a pair of dedicated earphones as backup.

Referring to FIG. 2, a diagram of an earphone 124 is shown and generally designated 200. The diagram 200 includes a left view 250 of the earphone 124 and a right view 280 of the earphone 124.

The earphone 124 includes a proximity sensor (PS) 260, a PS 262, and a PS 264. For example, the earphone 124 includes a housing configured to at least partially contain the PS 260, the PS 262, and the PS 264. The PS 260 (e.g., a first sensor) is configured to generate a PS output 270 (e.g., a first sensor output). For example, the PS 260 emits an electromagnetic field and the PS output 270 indicates changes in the electromagnetic field. As another example, the PS 260 emits a beam of electromagnetic radiation (e.g., infrared) or vibration (e.g., ultrasound) and the PS output 270 indicates a return signal. Similarly, the PS 262 (e.g., a second sensor) and the PS 264 (e.g., a third sensor) are configured to generate a PS output 272 (e.g., a second sensor output) and a PS output 274 (e.g., a third sensor output), respectively. It should be understood that three PSs are described herein for ease of illustration. In some implementations, the earphone 124 includes fewer than three PSs or more than three PSs.

The PS 260 is located at or near a center of the earphone 124. The PS output 270 is indicative of whether the earphone 124 is inserted in an ear. The PS 262 is located on a left side of the earphone 124. The PS 264 is located on a right side of the earphone 124. When the earphone 124 is inserted in a left ear, the PS 262 may be facing a wall of the left ear and the PS 264 may be facing a left ear canal. Alternatively, when the earphone 124 is inserted in a right ear, the PS 262 may be facing a right ear canal and the PS 264 may be facing a wall of the right ear.

The control circuitry 148, responsive to the PS output 270, updates the control signal 121 based on a comparison between the PS output 272 and the PS output 274. For example, a sensor comparator 206 of the control circuitry 148, responsive to the PS output 270, generates the control signal 121 corresponding to a difference between the PS output 272 and the PS output 274. To illustrate, when the earphone 124 is inserted in an ear, the PS output 270 is greater than an activation threshold of the sensor comparator 206. The sensor comparator 206 is activated when the PS output 270 is greater than the activation threshold. When the earphone 124 is inserted in a left ear, the PS 262 may be facing a wall of the left ear and the PS 264 may be facing a left ear canal. A difference (e.g., a positive difference) between the PS output 272 and the PS output 274 corresponding to a first value (e.g., 0) of the control signal 121 may indicate that the earphone 124 is inserted in a left ear. Alternatively, when the earphone 124 is inserted in a right ear, the PS 262 may be facing a right ear canal and the PS 264 may be facing a wall of the right ear. A difference (e.g., a negative difference) between the PS output 272 and the PS output 274 corresponding to a second value (e.g., 1) of the control signal 121 may indicate that the earphone 124 is inserted in a right ear.

In FIG. 2, the diagram 200 also includes a table 204 of the PS output 270, a PS output comparison 202, and corresponding values of the configuration 141. For example, the table 204 indicates that when the PS output 270 indicates that the earphone 124 is not inserted in an ear, the configuration 141 is not updated (“no change”). To illustrate, when the PS output 270 is less than or equal to the activation threshold of the sensor comparator 206, the control signal 121 corresponds to a particular value (e.g., −1) and the decoder 142 refrains from updating the configuration 141 based on the particular value (e.g., −1) of the control signal 121.

The table 204 indicates that when the PS output 270 indicates that the earphone 124 is inserted in an ear and when the PS output 272 is greater than the PS output 274, the configuration 141 is set to the left configuration 143. For example, the decoder 142 sets the configuration 141 to the left configuration 143 in response to determining that the control signal 121 corresponds to a first value (e.g., 0). The control signal 121 corresponds to the first value (e.g., 0) when the PS output 272 is greater than the PS output 274 (e.g., PS output 272 >PS output 274). For example, the sensor comparator 206 outputs the control signal 121 corresponding to the first value (e.g., 0) in response to determining that a difference between the PS output 272 and the PS output 274 is greater than 0 (e.g., PS output 272−PS output 274>0).

The table 204 indicates that when the PS output 270 indicates that the earphone 124 is inserted in an ear and when the PS output 272 is less than the PS output 274, the configuration 141 is set to the right configuration 145. For example, the decoder 142 sets the configuration 141 to the right configuration 145 in response to determining that the control signal 121 corresponds to a second value (e.g., 1). The control signal 121 corresponds to the second value (e.g., 1) when the PS output 272 is less than the PS output 274 (e.g., PS output 272<PS output 274). For example, the sensor comparator 206 outputs the control signal 121 corresponding to the second value (e.g., 1) in response to determining that a difference between the PS output 272 and the PS output 274 is less than 0 (e.g., PS output 272−PS output 274<0). The sensor comparator 206, in response to determining that the difference between the PS output 272 and the PS output 274 is equal to 0, outputs the control signal 121 corresponding to a particular value (e.g., −1). The decoder 142 refrains from updating the configuration 141 based on the particular value (e.g., −1) of the control signal 121. It should be understood that three PSs are described for ease of illustration. In some implementations, the earphone 124 includes more than three PSs or fewer than three PSs.

In a particular aspect, the control circuitry 148 detects a communication initiation phase, the update phase, or both, as described with reference to FIG. 1, in response to determining that the PS output 270 has changed from indicating that the earphone 124 is not inserted into an ear to indicating that the earphone 124 is inserted into an ear. For example, the control circuitry 148 detects the communication phase, the update phase, or both, in response to determining that the PS output 270 has changed from being less than or equal to the activation threshold to being greater than the activation threshold.

In a particular aspect, the decoder 142 detects a communication initiation phase, the update phase, or both, as described with reference to FIG. 1, in response to determining that the control signal 121 has changed from indicating that the earphone 124 is not inserted into an ear to indicating that the earphone 124 is inserted into an ear. For example, the decoder 142 detects the communication initiation phase, the update phase, or both, in response to determining that the control signal 121 has changed from indicating the particular value (e.g., −1) to indicating the first value (e.g., 0) or the second value (e.g., 1).

The PSs 260-264 enable the control circuitry 148 to output the control signal 121 based on the PS outputs 270-274. The decoder 142 of FIG. 1 may, responsive to the control signal 121, automatically update the configuration 141 to correspond to the ear in which the earphone 124 is inserted.

Referring to FIG. 3, a system operable to perform audio coding based on wireless earphone configuration is shown and generally designated 300. The system 300 may correspond to the system 100 of FIG. 1. For example, the system 100 includes one or more components of the system 300. The source device 102 includes wireless communication circuitry 340 coupled to an audio mode selector 320. The audio mode selector 320 is coupled to an encoder 332.

The wireless communication circuitry 340 is configured to communicate, in accordance with an AVRCP protocol 346, with the earphone 124 of FIG. 1. For example, the wireless communication circuitry 340 is configured to communicate, in accordance with the AVRCP protocol 346, with the first earphone 104, the second earphone 106, or both. In a particular aspect, the AVRCP protocol 346 is the same as the AVRCP protocol 156. In some implementations, the AVRCP protocol 346 corresponds to the same version of the AVRCP protocol as the AVRCP protocol 156.

In other implementations, the AVRCP protocol 346 is distinct from the AVRCP protocol 156. For example, the AVRCP protocol 346 corresponds to a first version of the AVRCP protocol, the AVRCP protocol 156 corresponds to a second version of the AVRCP protocol, and the first version is distinct form the second version. The first version (e.g., AVRCP protocol version 1.6) may be compatible with the second version (e.g., AVRCP protocol version 1.5). For example, the first version is backwards compatible with the second version, or vice versa.

The wireless communication circuitry 340 includes a command decoder 347. The command decoder 347 is configured to decode a command of the AVRCP protocol 346. For example, the command decoder 347 is configured to determine a command type of the command, an opcode of the command, an operation identifier (ID) of the command, operation data of the command, or a combination thereof.

The audio mode selector 320 is configured to determine an audio mode 342 based on the first configuration 160, the second configuration 161, or both, as further described with reference to FIG. 4. The encoder 332 is configured to generate an encoded signal based on the audio mode 342, as described herein.

During operation, the first earphone 104 sends the first notification 114 to the source device 102, as described with reference to FIG. 1. The second earphone 106 may send the second notification 116 to the source device 102. The first notification 114, the second notification 116, or both, correspond to a notification 314. Values of one or more fields of the first notification 114 may be the same as or distinct from values of one or more fields of the second notification 116.

The notification 314 (e.g., the first notification 114 or the second notification 116) has a format that includes a command type field 302, an opcode field 304, an operation ID field 306, an operation data field 308, or a combination thereof. The wireless communication circuitry 140 of FIG. 1 sets the command type field 302 of the notification 314 to a particular value indicating that the notification 314 corresponds to a control command 312 of the AVRCP protocol 156 of FIG. 1, the AVRCP protocol 346, or both. The wireless communication circuitry 140 of FIG. 1 sets the opcode field 304 of the notification 314 to a particular value indicating a pass through opcode 318 of the AVRCP protocol 156 of FIG. 1, the AVRCP protocol 346, or both. The wireless communication circuitry 140 of FIG. 1 sets the operation ID field 306 of the notification 314 to a particular value indicating a stream selection operation identifier 316. The wireless communication circuitry 140 of FIG. 1 sets the operation data field 308 of the notification 314 to a particular value indicating the configuration 141. For example, the wireless communication circuitry 140 of the first earphone 104 sets the operation data field 308 of the first notification 114 to a particular value indicating the first configuration 160. As another example, the wireless communication circuitry 140 of the second earphone 106 sets the operation data field 308 of the second notification 116 to a particular value indicating the second configuration 161. The first earphone 104 transmits the first notification 114 to the source device 102, and the second earphone 106 transmits the second notification 116 to the source device 102.

The source device 102 receives, at a first time, the first notification 114 (e.g., the notification 314) from the first earphone 104. The command decoder 347, in response to receiving the notification 314, determines that the value of the command type field 302 indicates that the notification 314 corresponds to the control command 312 of the AVRCP protocol 346. The command decoder 347 determines that the value of the opcode field 304 indicates the pass through opcode 318 and that the value of the operation ID field 306 indicates the stream selection operation ID 316. The command decoder 347, in response to determining that the notification 314 corresponds to the control command 312, that the notification 314 includes the pass through opcode 318, and that the notification 314 includes the stream selection operation ID 316, determines that the operation data field 308 indicates the configuration 141. For example, the command decoder 347 determines the first configuration 160 corresponding to a value of the operation data field 308 of the first notification 114.

In a particular implementation, the wireless communication circuitry 340 selects a speech signal corresponding to the first configuration 160 from a plurality of speech signals. For example, the wireless communication circuitry 340 selects the speech signal in response to determining that the speech signal indicates the first configuration 160. To illustrate, text (e.g., “left” or “right”) associated with the speech signal indicates that the speech signal corresponds to speech including at least a word (e.g., “left” or “right”) that indicates the first configuration 160 (e.g., the left configuration 143 or the right configuration 145). The wireless communication circuitry 340 transmits the speech signal to the first earphone 104. The first earphone 104 may output the speech signal via a speaker.

In a particular aspect, the source device 102 receives, at a second time, the second notification 116 from the second earphone 106. The command decoder 347 determines the second configuration 161 corresponding to a value of the operation data field 308 of the second notification 116. The wireless communication circuitry 340 may select a speech signal corresponding to the second configuration 161 from a plurality of speech signals. The wireless communication circuitry 340 may transmit the speech signal to the second earphone 106. In this aspect, the command decoder 347 provides the first configuration 160 of the first earphone 104 and the second configuration 161 of the second earphone 106 to the audio mode selector 320. In a particular implementation, each of the first notification 114 and the second notification 116 includes the same group identifier and the command decoder 347 provides data to the audio mode selector 320 indicating that the first earphone 104 is associated with the same group as the second earphone 106.

The audio mode selector 320 may wait for a particular time to allow multiple earphones to send notifications before selecting the audio mode 342. In some examples, the command decoder 347 determines that no related notification has been received at the source device 102 within a time interval (e.g., a threshold time interval) subsequent to the first time. For example, the source device 102 determines that no notification has been received from any earphone within the time interval. In other examples, the source device 102 determines that notification including the group identifier has been received from one or more earphones within the time interval. Duration of the time interval is based on a default value, a user input, a configuration setting, or a combination thereof. The audio mode selector 320 selects the audio mode 342 (e.g., a stereo mode or a mono mode) based on the first configuration 160, the second configuration 161, or both, as further described with reference to FIG. 4. The audio mode selector 320 provides the audio mode 342 to the encoder 332. The encoder 332 generates the audio signal 112 based on the audio mode 342. For example, the encoder 332 generates the audio signal 112 to include multiple audio channels (e.g., multiple audio streams) in response to determining that the audio mode 342 includes a stereo mode. As another example, the encoder 332 generates the audio signal 112 to include a single audio channel (e.g., a single audio stream) in response to determining that the audio mode 342 includes a mono mode. In a particular implementation, the single audio channel (e.g., a left audio channel or a right audio channel) corresponds to one of the multiple audio channels. In this implementation, some of the data corresponding to the remaining audio channels is excluded from the audio signal 112. In an alternative implementation, the single audio channel (e.g., an average audio channel) corresponds to a combination of the multiple audio channels. In this implementation, data corresponding to the multiple audio channels is included in the audio signal 112 as corresponding to the single audio channel.

The wireless communication circuitry 340 transmits the audio signal 112 to the first earphone 104, the second earphone 106, or both. For example, the wireless communication circuitry 340 transmits the audio signal 112 to the first earphone 104 in response to receiving the first notification 114. The wireless communication circuitry 340 transmits the audio signal 112 to the first earphone 104 and to the second earphone 106 in response to receiving the second notification 116 within a time interval of receiving the first notification 114.

The system 300 thus enables the source device 102 to select the audio mode 342 based on configurations of one or more earphones. The source device 102 generates the audio signal 112 based on the audio mode 342 and provides the audio signal 112 to the earphones.

Referring to FIG. 4, a table is shown and generally designated 400. The table 400 indicates a value of the audio mode 342 corresponding to a value of the first configuration 160, the second configuration 161, or both.

The table 400 depicts an example of operation of the audio mode selector 320 of FIG. 3 that receives the first configuration 160 of the first earphone 104 and the second configuration 161 of the second earphone 106 from the command decoder 347 of FIG. 3. The audio mode selector 320 determines that the second configuration 161 of the second earphone 106 is related to the first configuration 160 of the first earphone 104 in response to receiving an indicator (e.g., a group identifier) from the command decoder 347 indicating that the first earphone 104 is associated with the same group as the second earphone 106, as described with reference to FIG. 3. The audio mode selector 320, in response to determining that the second configuration 161 is related to the first configuration 160, selects the audio mode 342 based on the first configuration 160 and the second configuration 161, as described herein.

The table 400 indicates that the audio mode 342 corresponds to a mono mode 404 (e.g., a left mono mode) when each of the first configuration 160 and the second configuration 161 includes the left configuration 143. For example, the audio mode selector 320 of FIG. 3 selects the mono mode 404 (e.g., the left mono mode) as the audio mode 342 in response to determining that each of the first configuration 160 and the second configuration 161 includes the left configuration 143.

The table 400 indicates that the audio mode 342 corresponds to a mono mode 408 (e.g., a right mono mode) when each of the first configuration 160 and the second configuration 161 includes the right configuration 145. For example, the audio mode selector 320 of FIG. 3 selects the mono mode 408 (e.g., the right mono mode) as the audio mode 342 in response to determining that each of the first configuration 160 and the second configuration 161 includes the right configuration 145. The table 400 thus indicates that the audio mode 342 corresponds to a mono mode (e.g., the mono mode 404 or the mono mode 408) when the first configuration 160 matches the second configuration 161. In a particular aspect, the mono mode 404 is the same (e.g., a mono mode) as the mono mode 408.

The table 400 indicates that the audio mode 342 corresponds to a stereo mode 406 when one of the first configuration 160 or the second configuration 161 includes the right configuration 145 and the other of the first configuration 160 or the second configuration 161 includes the left configuration 143. For example, the audio mode selector 320 of FIG. 3 selects the stereo mode 406 as the audio mode 342 in response to determining that one of the first configuration 160 or the second configuration 161 includes the right configuration 145 and that the other of the first configuration 160 or the second configuration 161 includes the left configuration 143.

The table 400 indicates that the audio mode 342 corresponds to the mono mode 408 (e.g., the right mono mode) when the first configuration 160 includes the right configuration 145 and the second configuration 161 is absent (e.g., the second notification 116 is not received within a time interval of receiving the first notification 114, such as when the second earphone 106 is not within a communication range of the source device 102, when the second earphone 106 is deactivated, or both). The table 400 indicates that the audio mode 342 corresponds to the mono mode 404 (e.g., the left mono mode) when the first configuration 160 includes the left configuration 143 and the second configuration 161 is absent.

The table 400 thus illustrates automatic selection of the audio mode 342 corresponding to the first configuration 160, the second configuration 161, or both. For example, the audio mode selector 320 of FIG. 3 automatically selects the audio mode 342 based on the first configuration 160, the second configuration 161, or both. The encoder 332 generates the audio signal 112 based on the audio mode 342. The encoder 332 transmits the audio signal 112 to the first earphone 104, the second earphone 106, or both.

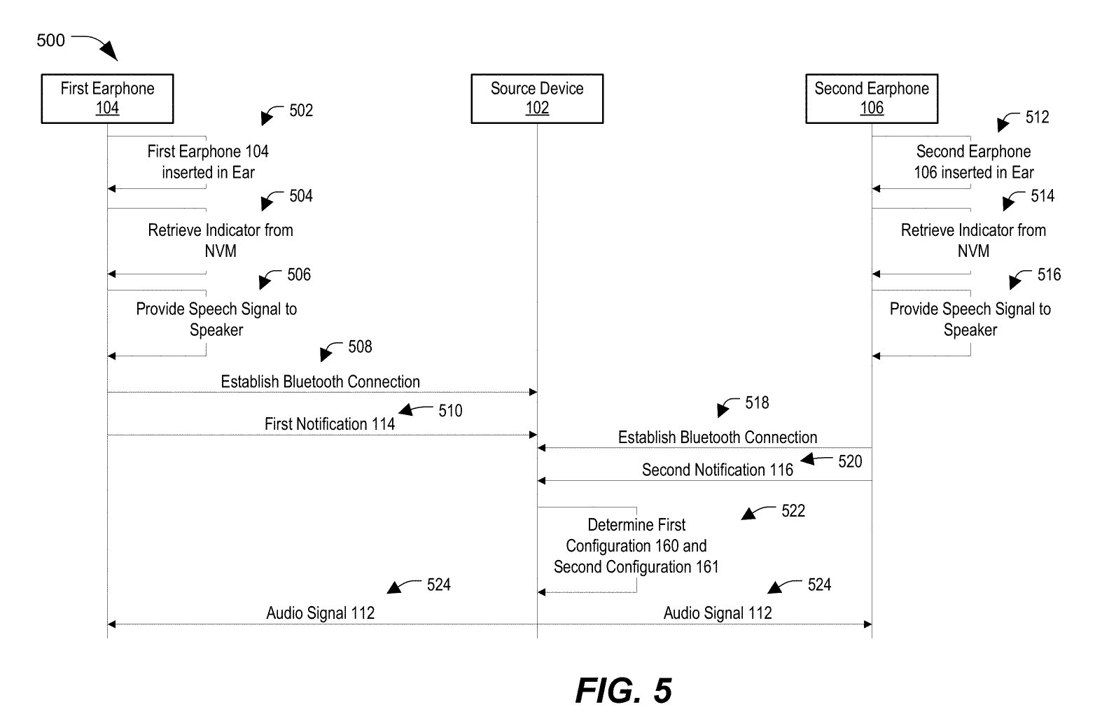

Referring to FIG. 5, a method of performing audio coding based on wireless earphone configuration is shown and generally designated 500. In a particular aspect, components of the method 500 are performed by the first earphone 104, the source device 102, the second earphone 106, the system 100 of FIG. 1, or a combination thereof.

The method 500 includes insertion of the first earphone 104 in an ear, at 502. For example, as described with reference to FIG. 2, the PS output 270 of the PS 260 of the earphone 124 (e.g., the first earphone 104) indicates, at a first time, that the earphone 124 is inserted in an ear.

The method 500 also includes retrieving an indicator from an NVM, at 504. For example, the processor 130 of FIG. 1 retrieves the indicator 147 from the NVM 146 of the earphone 124 (e.g., the first earphone 104), as described with reference to FIG. 1. To illustrate, the processor 130 retrieves the indicator 147 from the NVM 146 in response to detecting a communication initiation phase of the earphone 124 (e.g., the first earphone 104), as described with reference to FIG. 1. In a particular aspect, the first earphone 104 is inserted in the ear at a first time and the indicator 147 (e.g., the retrieved indicator) indicates a previous configuration (e.g., the configuration 141) of the first earphone 104. For example, the indicator 147 indicates the configuration 141 that the first earphone 104 had prior to the first time, such as during a previous insertion of the first earphone 104 in an ear. In another aspect, the indicator 147 (e.g., the retrieved indicator) indicates the configuration 141 determined based on the PS outputs 270-274 that are detected at approximately the first time.

The method 500 further includes providing a speech signal to a speaker, at 506. For example, the decoder 142 of FIG. 1 provides the speech signal 151 to the speaker 144 of the earphone 124 (e.g., the first earphone 104), as described with reference to FIG. 1. The speech signal 151 indicates the configuration 141 corresponding to the indicator 147.

The method 500 also includes the first earphone 104 establishing a connection with the source device 102, at 508. For example, the wireless communication circuitry 140 of the earphone 124 (e.g., the first earphone 104) establishes a Bluetooth® connection with the wireless communication circuitry 340 of the source device 102. To illustrate, the wireless communication circuitry 140 transmits a request including a passkey to the wireless communication circuitry 340. The wireless communication circuitry 340 determines that the Bluetooth® connection is established in response to determining that the received passkey matches a stored passkey. The wireless communication circuitry 340 may transmit a notification to the wireless communication circuitry 140 indicating that the Bluetooth® connection is established successfully.

The method 500 further includes transmitting the first notification 114 from the first earphone 104 to the source device 102, at 510. For example, the wireless communication circuitry 140 of the earphone 124 (e.g., the first earphone 104) transmits the first notification 114 in accordance with the AVRCP protocol 156 to the source device 102, as described with reference to FIG. 1.

The method 500 also includes insertion of the second earphone 106 in an ear, at 512. For example, as described with reference to FIG. 2, the PS output 270 of the PS 260 of the earphone 124 (e.g., the second earphone 106) indicates, at a first time, that the earphone 124 is inserted in an ear.

The method 500 further includes retrieving an indicator from an NVM, at 514. For example, the processor 130 of FIG. 1 retrieves the indicator 147 from the NVM 146 of the earphone 124 (e.g., the second earphone 106), as described with reference to FIG. 1. To illustrate, the processor 130 retrieves the indicator 147 from the NVM 146 in response to detecting a communication initiation phase of the earphone 124 (e.g., the second earphone 106), as described with reference to FIG. 1. In a particular aspect, the second earphone 106 is inserted in the ear at a second time and the indicator 147 indicates a previous configuration (e.g., the configuration 141) of the second earphone 106. In another aspect, the indicator 147 indicates the configuration 141 determined based on the PS outputs 270-274 that are detected at approximately the second time.

The method 500 also includes providing a speech signal to a speaker, at 516. For example, the decoder 142 of FIG. 1 provides the speech signal 151 to the speaker 144 of the earphone 124 (e.g., the second earphone 106), as described with reference to FIG. 1. The speech signal 151 indicates the configuration 141 corresponding to the indicator 147.

The method 500 further includes the second earphone 106 establishing a connection with the source device 102, at 518. For example, the wireless communication circuitry 140 of the earphone 124 (e.g., the second earphone 106) establishes a Bluetooth® connection with the wireless communication circuitry 340 of the source device 102.

The method 500 also includes transmitting the second notification 116 from the second earphone 106 to the source device 102, at 520. For example, the wireless communication circuitry 140 of the earphone 124 (e.g., the second earphone 106) transmits the second notification 116 in accordance with the AVRCP protocol 156 to the source device 102, as described with reference to FIG. 1.

The method 500 further includes determining, at the source device 102, the first configuration 160 and the second configuration 161, at 522. For example, as described with reference to FIG. 3, the command decoder 347 determines the first configuration 160 and the second configuration 161 based on the indications received via the first notification 114 and the second notification 116, respectively.

The method 500 also includes transmitting the audio signal 112 from the source device 102 to the first earphone 104 and the second earphone 106, at 524. For example, as described with reference to FIG. 3, the audio mode selector 320 selects the audio mode 342 based on the first configuration 160 and the second configuration 161. The encoder 332 generates the audio signal 112 based on the audio mode 342, and the wireless communication circuitry 340 transmits the audio signal 112 to the first earphone 104 and to the second earphone 106.

The method 500 thus enables the first earphone 104 to automatically determine the first configuration 160 based on a stored indicator (e.g., the indicator 147). Similarly, the second earphone 106 automatically determines the second configuration 161 based on a stored indicator (e.g., the indicator 147). The first earphone 104 provides the first configuration 160 to the source device 102. The second earphone 106 provides the second configuration 161 to the source device 102. The source device 102 generates the audio signal 112 based on the first configuration 160 and the second configuration 161 and provides the audio signal 112 to the first earphone 104 and to the second earphone 106.

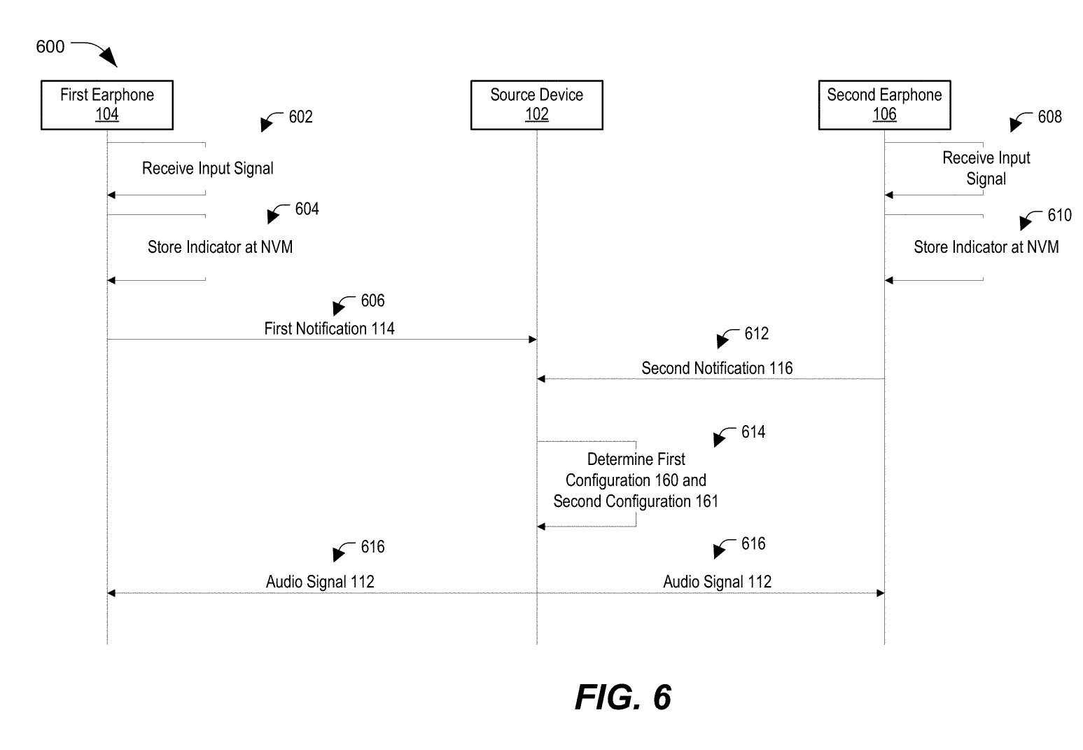

Referring to FIG. 6, a method of performing audio coding based on wireless earphone configuration based on receiving input signals is shown and generally designated 600. In a particular aspect, components of the method 600 are performed by the first earphone 104, the source device 102, the second earphone 106, the system 100 of FIG. 1, or a combination thereof.

The method 600 includes the first earphone 104 receiving an input signal, at 602. For example, the earphone 124 (e.g., the first earphone 104) receives the input signal 152, as described with reference to FIG. 1.

The method 600 also includes the first earphone 104 storing an indicator in a NVM, at 604. For example, the control circuitry 148 of the earphone 124 (e.g., the first earphone 104), responsive to the input signal 152, updates the control signal 121 to change the configuration 141 of the decoder 142, the indicator 147 stored in the NVM 146, or both, as described with reference to FIG. 1.

The method 600 further includes transmitting the first notification 114 from the first earphone 104 to the source device 102, at 606. For example, the wireless communication circuitry 140 of the earphone 124 (e.g., the first earphone 104) transmits the first notification 114 in accordance with the AVRCP protocol 156 to the source device 102, as described with reference to FIG. 1.

The method 600 also includes the second earphone 106 receiving an input signal, at 608. For example, the earphone 124 (e.g., the second earphone 106) receives the input signal 152, as described with reference to FIG. 1.

The method 600 further includes the second earphone 106 storing an indicator in a NVM, at 610. For example, the control circuitry 148 of the earphone 124 (e.g., the second earphone 106), responsive to the input signal 152, updates the control signal 121 to change the configuration 141 of the decoder 142, the indicator 147 stored in the NVM 146, or both, as described with reference to FIG. 1.

The method 600 also includes transmitting the second notification 116 from the second earphone 106 to the source device 102, at 612. For example, the wireless communication circuitry 140 of the earphone 124 (e.g., the second earphone 106) transmits the second notification 116 in accordance with the AVRCP protocol 156 to the source device 102, as described with reference to FIG. 1.

The method 600 further includes determining, at the source device 102, the first configuration 160 and the second configuration 161, at 614. For example, as described with reference to FIG. 3, the command decoder 347 determines the first configuration 160 and the second configuration 161 based on the indications received via the first notification 114 and the second notification 116, respectively.

The method 600 also includes transmitting the audio signal 112 from the source device 102 to the first earphone 104 and the second earphone 106, at 616. For example, as described with reference to FIG. 3, the audio mode selector 320 selects the audio mode 342 based on the first configuration 160 and the second configuration 161. The encoder 332 generates the audio signal 112 based on the audio mode 342, and the wireless communication circuitry 340 transmits the audio signal 112 to the first earphone 104 and to the second earphone 106.

The method 600 thus enables the first earphone 104 to determine the first configuration 160 based on a first input signal (e.g., the input signal 152). The first earphone 104 receives the input signal 152 from the input device 154. A user may override an automatic setting of the first configuration 160 by activating the input device 154 to generate the input signal 152. Similarly, the second earphone 106 determines the second configuration 161 based on a second input signal (e.g., the input signal 152). The first earphone 104 provides the first configuration 160 to the source device 102. The second earphone 106 provides the second configuration 161 to the source device 102. The source device 102 generates the audio signal 112 based on the first configuration 160 and the second configuration 161 and provides the audio signal 112 to the first earphone 104 and to the second earphone 106.

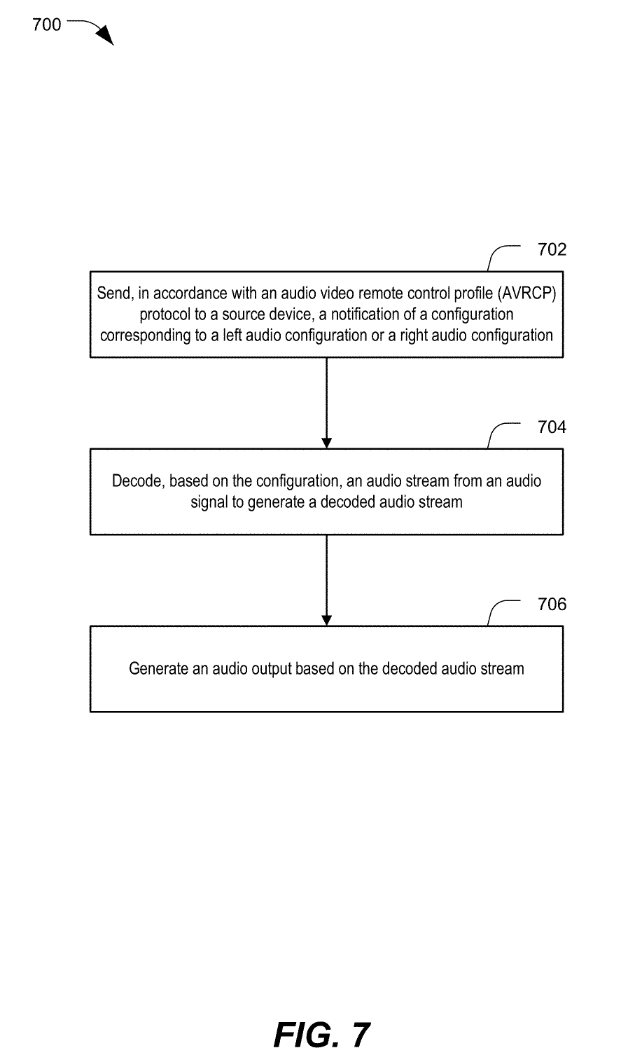

Referring to FIG. 7, a method of audio decoding based on wireless earphone configuration is shown and generally designated 700. The method 700 is performed by the earphone 124, the first earphone 104, the second earphone 106, the wireless communication circuitry 140, the decoder 142, the speaker 144, the system 100 of FIG. 1, or a combination thereof.

The method 700 includes sending, in accordance with an audio video remote control profile (AVRCP) protocol to a source device, a notification of a configuration corresponding to a left audio configuration or a right audio configuration, at 702. For example, the wireless communication circuitry 140 of FIG. 1 sends, in accordance with the AVRCP protocol 156 to the source device 102, the notification 314 of the configuration 141, as described with reference to FIGS. 1 and 3. The configuration 141 corresponds to the left configuration 143 or the right configuration 145.

The method 700 also includes decoding, based on the configuration, an audio stream from an audio signal to generate a decoded audio stream, at 704. For example, the decoder 142 of FIG. 1 decodes, based on the configuration 141, an audio stream from the audio signal 112 to generate the decoded audio stream 149, as described with reference to FIG. 1.

The method 700 further includes generating an audio output based on the decoded audio stream, at 706. For example, the speaker 144 of FIG. 1 generates an audio output based on the decoded audio stream 149.

The method 700 thus enables the earphone 124 to transmit the notification 314 of the configuration 141 in accordance with the AVRCP protocol 156 to the source device 102. The source device 102 generates the audio signal 112 based at least in part on the configuration 141. The earphone 124 generates the decoded audio stream 149 based on the configuration 141. The speaker 144 generates an audio output based on the decoded audio stream 149. A user thus hears, via the earphone 124, an audio output that is at least in part based on the configuration 141 of the earphone 124.

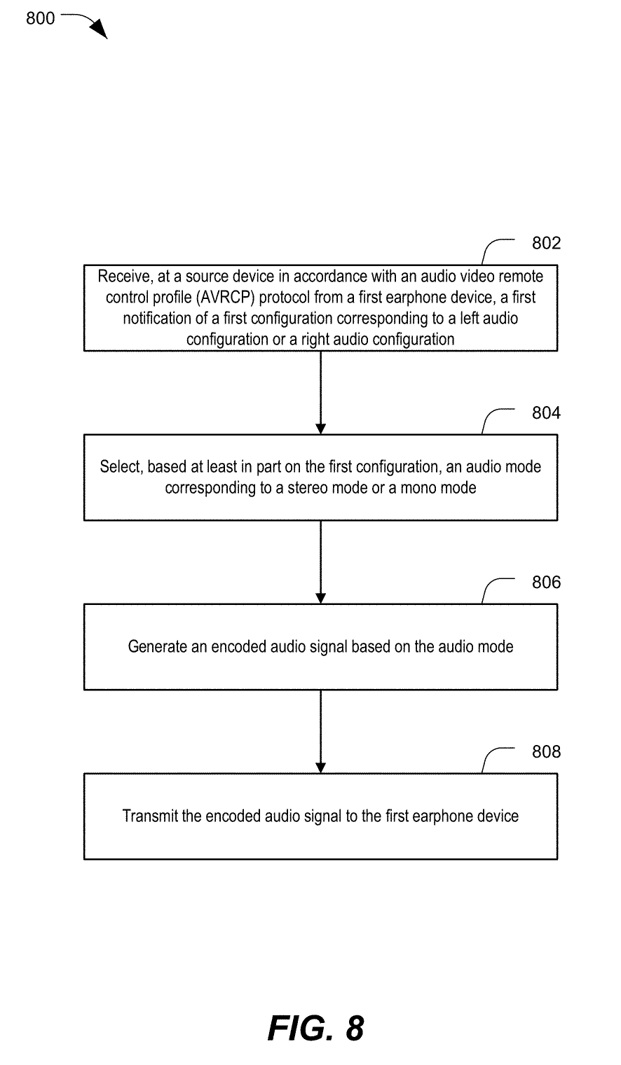

Referring to FIG. 8, a method of audio encoding based on wireless earphone configuration is shown and generally designated 800. The method 800 is performed by the source device 102, the system 100 of FIG. 1, the wireless communication circuitry 340, the audio mode selector 320, the encoder 332, the system 300 of FIG. 3, or a combination thereof.

The method 800 includes receiving, at a source device in accordance with an audio video remote control profile (AVRCP) protocol from a first earphone device, a first notification of a first configuration corresponding to a left audio configuration or a right audio configuration, at 802. For example, as described with reference to FIG. 3, the source device 102 receives, in accordance with the AVRCP protocol 346 from the first earphone 104, the first notification 114 of the first configuration 160. The first configuration 160 corresponds to the left configuration 143 or the right configuration 145, as further described with reference to FIG. 1.

The method 800 also includes selecting, based at least in part on the first configuration, an audio mode corresponding to a stereo mode or a mono mode, at 804. For example, as described with reference to FIGS. 3-4, the audio mode selector 320 selects, based at least in part on the first configuration 160, the audio mode 342 corresponding to the stereo mode 406, the mono mode 404, or the mono mode 408.

The method 800 further includes generating an encoded audio signal based on the audio mode, at 806. For example, as described with reference to FIG. 3, the encoder 332 generates the audio signal 112 (e.g., an encoded audio signal) based on the audio mode 342.

The method 800 also includes transmitting the encoded audio signal to the first earphone device, at 808. For example, as described with reference to FIG. 3, the wireless communication circuitry 340 transmits the audio signal 112 (e.g., the encoded audio signal) to the first earphone 104.

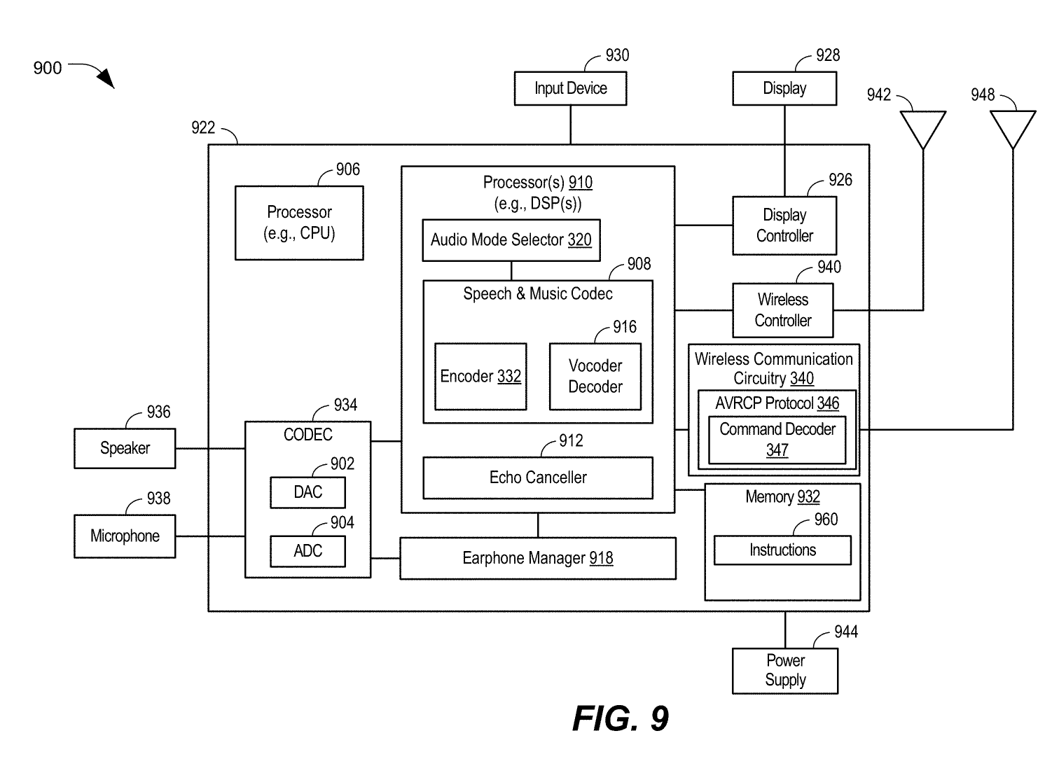

Referring to FIG. 9, a block diagram of a particular illustrative example of a device (e.g., a wireless communication device) is depicted and generally designated 900. In various examples, the device 900 includes fewer or more components than illustrated in FIG. 9. In an illustrative example, the device 900 corresponds to the source device 102 of FIG. 1. In an illustrative example, the device 900 performs one or more operations described with reference to FIGS. 1-8.

In a particular aspect, the device 900 includes a processor 906 (e.g., a central processing unit (CPU)). The device 900 may include one or more additional processor(s) 910 (e.g., one or more digital signal processors (DSPs)). The processor(s) 910 include a speech and music coder-decoder (CODEC) 908, an echo canceller 912, the audio mode selector 320, or a combination thereof. The speech and music CODEC 908 includes the encoder 332 (e.g., a vocoder encoder), a vocoder decoder 916, or both.

The encoder 332 may also include an earphone manager 918. The earphone manager 918 is configured manage one or more earphones. For example, the earphone manager 918 maintains connection data indicating which earphone have previously established a connection with the wireless communication circuitry 340. The wireless communication circuitry 340 send a request to the earphone manager 918 in response to receiving a connection request from the earphone 124 of FIG. 1. The earphone manager 918, in response to receiving the request from the wireless communication circuitry 340 and determining that the connection data indicates that the earphone 124 has not established a connection with the wireless communication circuitry 340 within a threshold duration (e.g., previous one year), instructs the wireless communication circuitry 340 to send a passcode request to the earphone 124. The wireless communication circuitry 340, in response to receiving a passcode from the earphone 124, provides the passcode to the earphone manager 918. The earphone manager 918, in response to determining that the passcode matches a stored passcode, updates the connection data at a first time to indicate that the earphone 124 has established a connection at the first time with the wireless communication circuitry 340 and instructs the wireless communication circuitry 340 to send a message to the earphone 124 indicating that the connection has been established. The earphone manager 918 thus enables the earphone 124 to establish the connection with the wireless communication circuitry 340 independently of providing the passcode with each connection request.

Although the speech and music CODEC 908 is illustrated as a component of the processor(s) 910, in other examples one or more components of the speech and music CODEC 908 are included in the processor 906, a CODEC 934, another processing component, or a combination thereof. The device 900 also includes a memory 932, a wireless controller 940 coupled to an antenna 942, and the wireless communication circuitry 340 coupled to an antenna 948. The device 900 includes a display 928 coupled to a display controller 926. A speaker 936, a microphone 938, or both may be coupled to the CODEC 934. The CODEC 934 may include a digital-to-analog converter (DAC) 902 and an analog-to-digital converter (ADC) 904.

In a particular aspect, the CODEC 934 may receive analog signals from the microphone 938, convert the analog signals to digital signals using the analog-to-digital converter 904, and provide the digital signals to the speech and music CODEC 908, such as in a pulse code modulation (PCM) format. The speech and music CODEC 908 may process the digital signals. In a particular aspect, the speech and music CODEC 908 may provide digital signals to the CODEC 934. The CODEC 934 may convert the digital signals to analog signals using the digital-to-analog converter 902 and may provide the analog signals to the speaker 936.

The memory 932 may include instructions 960 executable by the processor 906, the processor(s) 910, the CODEC 934, the earphone manager 918, another processing unit of the device 900, or a combination thereof, to perform methods and processes disclosed herein, such as one or more operations described with reference to FIGS. 1-8. One or more components of the systems and devices described with reference to FIGS. 1-8 may be implemented via dedicated hardware (e.g., circuitry), by a processor executing instructions (e.g., the instructions 960) to perform one or more tasks, or a combination thereof. As an example, the memory 932 or one or more components of the processor 906, the processor(s) 910, the earphone manager 918, and/or the CODEC 934 includes a memory device, such as a random access memory (RAM), magnetoresistive random access memory (MRAM), spin-torque transfer MRAM (STT-MRAM), flash memory, read-only memory (ROM), programmable read-only memory (PROM), erasable programmable read-only memory (EPROM), electrically erasable programmable read-only memory (EEPROM), registers, hard disk, a removable disk, or a compact disc read-only memory (CD-ROM). The memory device includes instructions (e.g., the instructions 960) that, when executed by a computer (e.g., a processor in the CODEC 934, the earphone manager 918, the processor 906, and/or the processor(s) 910), causes the computer to perform one or more operations described with reference to FIGS. 1-8. As an example, the memory 932 or the one or more components of the processor 906, the processor(s) 910, the earphone manager 918, the CODEC 934 is a non-transitory computer-readable medium that includes instructions (e.g., the instructions 960) that, when executed by a computer (e.g., a processor in the CODEC 934, the processor 906, and/or the processor(s) 910), cause the computer perform one or more operations described with reference to FIGS. 1-8.

In a particular aspect, the device 900 is included in a system-in-package or system-on-chip device 922, such as a mobile station modem (MSM). In a particular aspect, the processor 906, the processor(s) 910, the display controller 926, the memory 932, the CODEC 934, the earphone manager 918, the wireless controller 940, and the wireless communication circuitry 340 are included in a system-in-package or the system-on-chip device 922. In a particular aspect, an input device 930, such as a touchscreen and/or keypad, and a power supply 944 are coupled to the system-on-chip device 922. Moreover, in a particular aspect, as illustrated in FIG. 9, the display 928, the input device 930, the speaker 936, the microphone 938, the antenna 942, the antenna 948, and the power supply 944 are external to the system-on-chip device 922. However, each of the display 928, the input device 930, the speaker 936, the microphone 938, the antenna 942, the antenna 948, and the power supply 944 can be coupled to a component of the system-on-chip device 922, such as an interface or a controller. In an illustrative example, the device 900 corresponds to a mobile communication device, a smartphone, a cellular phone, a laptop computer, a computer, a tablet computer, a personal digital assistant, a display device, a television, a gaming console, a music player, a radio, a digital video player, an optical disc player, a tuner, a camera, a navigation device, a decoder system, an encoder system, or any combination thereof.

In an illustrative aspect, the processor(s) 910 is operable to perform audio coding based on wireless earphone configuration in accordance with the described techniques. For example, the wireless communication circuitry 340 receives the first notification 114 of FIG. 1 from the first earphone 104. The wireless communication circuitry 340 may also receive the second notification 116 of FIG. 1 from the second earphone 106. The command decoder 347 provides data to the audio mode selector 320 indicating that the first earphone 104 of FIG. 1 has the first configuration 160. The command decoder 347 may also provide data to the audio mode selector 320 indicating that the second earphone 106 of FIG. 1 has the second configuration 161. The audio mode selector 320 determines the audio mode 342 of FIG. 3 based on the first configuration 160, the second configuration 161, or both. The audio mode selector 320 provides the audio mode 342 to the encoder 332. The encoder 332 generates the audio signal 112 based on the audio mode 342. In a particular implementation, the encoder 332 compresses digital audio samples corresponding to the audio signal 112 and forms a transmit packet (e.g. a representation of the compressed bits of the digital audio samples). The transmit packet corresponds to at least a portion of the audio signal 112. The wireless communication circuitry 340 transmits the transmit packet via the antenna 948.

In conjunction with the described aspects, an apparatus is disclosed that includes first means for sending, in accordance with an audio video remote control profile (AVRCP) protocol to a source device, a notification of a configuration corresponding to a left audio configuration or a right audio configuration. For example, the means for sending include the first earphone 104, the second earphone 106, the earphone 124, the decoder 142, the processor 130, the wireless communication circuitry 140, the antenna 158 of FIG. 1, one or more devices configured to send a notification in accordance with the AVRCP protocol (e.g., a processor executing instructions stored at a computer-readable storage device), or any combination thereof.

The apparatus also includes means for decoding, based on the configuration, an audio stream from an audio signal to generate a decoded audio stream. For example, the means for decoding include the first earphone 104, the second earphone 106, the earphone 124, the decoder 142 of FIG. 1, one or more devices configured to decode the audio stream from an audio signal (e.g., a processor executing instructions stored at a computer-readable storage device), or any combination thereof.

The apparatus further includes means for generating an audio output based on the decoded audio stream. For example, the means for generating an audio output include the first earphone 104, the second earphone 106, the earphone 124, the speaker 144 of FIG. 1, one or more devices configured to generate an audio output based on a decoded audio stream (e.g., a processor executing instructions stored at a computer-readable storage device), or any combination thereof. At least one of the means for sending, the means for decoding, or the means for generating is integrated into an earphone device.

Those of skill would further appreciate that the various illustrative logical blocks, configurations, modules, circuits, and algorithm steps described in connection with the aspects disclosed herein may be implemented as electronic hardware, computer software executed by a processing device such as a hardware processor, or combinations of both. Various illustrative components, blocks, configurations, modules, circuits, and steps have been described above generally in terms of their functionality. Whether such functionality is implemented as hardware or executable software depends upon the particular application and design constraints imposed on the overall system. Skilled artisans may implement the described functionality in varying ways for each particular application, but such implementation decisions should not be interpreted as causing a departure from the scope of the present disclosure.

The steps of a method or algorithm described in connection with the aspects disclosed herein may be embodied directly in hardware, in a software module executed by a processor, or in a combination of the two. A software module may reside in a memory device, such as RAM, MRAM, STT-MRAM, flash memory, ROM, PROM, EPROM, EEPROM, registers, hard disk, a removable disk, or a CD-ROM. An exemplary memory device is coupled to the processor such that the processor can read information from, and write information to, the memory device. In the alternative, the memory device may be integral to the processor. The processor and the storage medium may reside in an ASIC. The ASIC may reside in a computing device or a user terminal. In the alternative, the processor and the storage medium may reside as discrete components in a computing device or a user terminal.

The previous description of the disclosed aspects is provided to enable a person skilled in the art to make or use the disclosed aspects. Various modifications to these aspects will be readily apparent to those skilled in the art, and the principles defined herein may be applied to other aspects without departing from the scope of the disclosure. Thus, the present disclosure is not intended to be limited to the aspects shown herein but is to be accorded the widest scope possible consistent with the principles and novel features as defined by the following claims.

1. An earphone device comprising:
wireless communication circuitry configured to send, in accordance with an audio video remote control profile (AVRCP) protocol to a source device, a notification of a configuration;
a decoder coupled to the wireless communication circuitry, the decoder configured to decode, based on whether the configuration corresponds to a left audio configuration or to a right audio configuration, a left channel of an audio stream from an audio signal or a right channel of the audio stream, respectively, to generate a decoded audio stream; and
a speaker coupled to the decoder, the speaker configured to generate an audio output based on the decoded audio stream.

2. The earphone device of claim 1, wherein:
the configuration is stored at the decoder, and
the wireless communication circuitry is further configured to generate the notification as a control command of the AVRCP protocol.

3. The earphone device of claim 1, further comprising control circuitry, wherein:
the notification comprises a pass through opcode of the AVRCP protocol, and
the decoder is further configured to set the configuration to the left audio configuration or to the right audio configuration based on a control signal from the control circuitry.

4. The earphone device of claim 1, further comprising control circuitry configured to determine which ear, of a left ear of a user and a right ear of the user, the earphone is coupled, wherein the notification comprises a stream selection operation identifier.

5. The earphone device of claim 1, wherein:
the notification comprises operation data that identifies the configuration, and
the source device is included in a mobile communication device configured to receive the notification.

6. The earphone device of claim 1, further comprising:
a non-volatile memory coupled to the decoder and to a processor, the non-volatile memory configured to store an identifier of the configuration; and
the processor configured to retrieve the identifier,
wherein the wireless communication circuitry is configured to generate the notification based on the retrieved identifier.

7. The earphone device of claim 1, wherein the wireless communication circuitry is further configured to receive a speech signal from the source device responsive to the notification, the speech signal indicating the configuration and a selection between the left channel and the right channel, and wherein the decoder is further configured to provide the speech signal to the speaker.

8. The earphone device of claim 1, wherein the decoder is further configured to:
select a speech signal from a plurality of speech signals based on determining that the speech signal indicates the configuration; and
provide the speech signal to the speaker.

9. The earphone device of claim 1, wherein the decoder is further configured to provide a speech signal to the speaker, the speech signal indicating the configuration.

10. The earphone device of claim 1, wherein the decoder is further configured to provide a speech signal to the speaker, wherein the configuration corresponds to the left audio configuration, and wherein the speech signal corresponds to speech including the word “left”.

11. The earphone device of claim 1, wherein the decoder is further configured to provide a speech signal to the speaker, wherein the configuration corresponds to the right audio configuration, and wherein the speech signal corresponds to speech including the word “right”.

12. The earphone device of claim 1, further comprising control circuitry coupled to the decoder, the control circuitry configured to:
receive an input signal from an input device; and
update the configuration based on the input signal.

13. The earphone device of claim 1, further comprising:
a first sensor configured to generate a first sensor output;
a second sensor configured to generate a second sensor output;
a third sensor configured to generate a third sensor output; and
a sensor comparator coupled to the first sensor, to the second sensor, to the third sensor, and to the decoder, the sensor comparator responsive to the first sensor output to selectively update the configuration based on a comparison between the second sensor output and the third sensor output.

14. The earphone device of claim 13, further comprising a housing configured to at least partially contain the first sensor, the second sensor, the third sensor, and the speaker.

15. A method comprising:
receiving, at a source device in accordance with an audio video remote control profile (AVRCP) protocol from a first earphone device, a first notification of a first audio configuration, the first audio configuration corresponding to a left audio configuration or a right audio configuration;
selecting, based at least in part on whether the first audio configuration corresponds to the left audio configuration or the first audio configuration corresponds to the right audio configuration, an audio mode corresponding to a stereo mode or a mono mode;
generating an encoded audio signal based on the audio mode; and
transmitting the encoded audio signal to the first earphone device.

16. The method of claim 15, wherein the source device includes a processor integrated into a mobile communication device, and further comprising determining that operation data of the first notification identifies the first audio configuration based on determining that the first notification corresponds to a control command of the AVRCP protocol and that the first notification includes a pass through opcode of the AVRCP protocol and a stream selection operation identifier.

17. The method of claim 15, further comprising:
receiving, at the source device in accordance with the AVRCP protocol from a second earphone device, a second notification of a second audio configuration corresponding to the left audio configuration or the right audio configuration; and
selecting the audio mode corresponding to the stereo mode based on determining that the first audio configuration is distinct from the second audio configuration.

18. The method of claim 15, further comprising:
receiving, at the source device in accordance with the AVRCP protocol from a second earphone device, a second notification of a second audio configuration corresponding to the left audio configuration or the right audio configuration, wherein the audio mode corresponding to the mono mode is selected based on determining that the first audio configuration matches the second audio configuration; and
transmitting the encoded audio signal to the second earphone device.

19. The method of claim 15, wherein the audio mode corresponding to the mono mode is selected by the source device based on determining that a second notification has not been received from a second earphone device within a threshold time interval of receiving the first notification from the first earphone device.

20. The method of claim 15, further comprising transmitting a speech signal to the first earphone device, the speech signal indicating the first audio configuration.

21. A computer-readable storage device storing instructions that, when executed by a processor, cause the processor to perform operations comprising:
sending, from an earphone device in accordance with an audio video remote control profile (AVRCP) protocol to a source device, a notification of a configuration;
decoding, based on whether the configuration corresponds to a left audio configuration or a right audio configuration, a left channel of an audio stream from an audio signal or a right channel of the audio stream, respectively, to generate a decoded audio stream; and
generating, at the earphone device, an audio output based on the decoded audio stream.

22. The computer-readable storage device of claim 21, wherein the operations further comprise generating the notification as a control command of the AVRCP protocol, the notification including a pass through opcode of the AVRCP protocol and a stream selection operation identifier.

23. The computer-readable storage device of claim 21, wherein the notification comprises operation data that identifies the configuration.

24. The computer-readable storage device of claim 21, wherein the operations further comprise:
receiving, at the earphone device, an input speech signal from a microphone; and
updating, based on determining that the input speech signal corresponds to speech including the word “left”, the configuration to indicate the left audio configuration.

25. The computer-readable storage device of claim 21, wherein the operations further comprise:
receiving, at the earphone device, an input speech signal from a microphone; and
updating, based on determining that the input speech signal corresponds to speech including the word “right”, the configuration to indicate the right audio configuration.

26. The computer-readable storage device of claim 21, wherein the operations further comprise:
receiving, at the earphone device, a first sensor output from a first sensor;
receiving, at the earphone device, a second sensor output from a second sensor;
receiving, at the earphone device, a third sensor output from a third sensor; and
selectively updating, responsive to the first sensor output, the configuration based on a comparison between the first sensor output and the second sensor output.

27. The computer-readable storage device of claim 21, wherein the operations further comprise providing a speech signal to a speaker, the speech signal indicating the configuration.

28. The computer-readable storage device of claim 21, wherein the operations further comprise:
receiving an input signal from an input device; and
updating the configuration based on the input signal.

29. An apparatus comprising:
means for sending, in accordance with an audio video remote control profile (AVRCP) protocol to a source device, a notification of a configuration;
means for decoding, based on whether the configuration corresponds to a left audio configuration or a right audio configuration, a left channel or a right channel of an audio stream from an audio signal to generate a decoded audio stream; and
means for generating an audio output based on the decoded audio stream.

30. The apparatus of claim 29, wherein at least one of the means for sending, the means for decoding, or the means for generating is integrated into an earphone device.
